(19) United States
(12) Patent Application Publication
(10) Pub. No.: US 2003/0022679 A1
(43) Pub. Date: Jan. 30, 2003

(54) Method for automatically adjusting time difference of cellular phone international roaming

(75) Inventors: Kun-Huei Chen, Taipei Hsieng (TW); Yung-Feng Wang, Taipei Hsieng (TW)

Correspondence Address: BACON & THOMAS, PLLC, 625 SLATERS LANE, FOURTH FLOOR, ALEXANDRIA, VA, 22314

(73) Assignee: Inventec Appliances Corp., Hsieng (TW)

(21) Appl. No.: 09/912,514

(22) Filed: Jul. 26, 2001

(51) Int. Cl. H04B 7/005

(52) U.S. Cl. 455/502; 455/503; 455/525

(57) ABSTRACT

In a cellular phone having a memory with a data base for storing a time conversion table regarding time of one place in the world belonging to a first telephone system and corresponding time of the other place in the world belonging to a second telephone system different from the first one, a method for automatically adjusting a time difference between the cellular phone and a connected base station during an international roaming comprises the steps of when a CPU of the cellular phone determines that an associated telephone system is different from that of the connected base station, the telephone system accessing the data base and looking up the conversion table for retrieving a corresponding time of the connected base station with respect to the cellular phone; and showing the corresponding time as a local time on a display of the cellular phone.

### FIELD OF THE INVENTION

The present invention relates to the field of time conversion of different time zones and more particularly to a method for automatically converting time of a cellular phone international roaming into a local time when connected to a base station in a different time zone.

### BACKGROUND OF THE INVENTION

Cellular phones have been widely used through out the world. Further, there is no end for such booming because among other advantageous benefits as compared to conventional wire telephone, cellular phone is slim, multifunctional, inexpensive, portable, and convenient while still maintaining a high communication quality. Hence, more and more people like to use cellular phones whether for business or social purpose. But there is a drawback associated with cellular phone, i.e., there is no way to automatically convert time of an international roaming initiated by a cellular phone into a local time when connected to a base station in a different time zone. Typically, cellular phone user has to do the time difference adjustment through a series of complex steps by oneself. Hence, it is very inconvenient.

### SUMMARY OF THE INVENTION

It is therefore an object of the present invention to provide, in a cellular phone having a memory with an embedded data base for storing a time conversion table regarding information about time of one of a plurality of places in the world belonging to a first telephone system and a corresponding time of the other place in the world belonging to a second telephone system different from the first telephone system, a method for automatically adjusting a time difference between the cellular phone and a connected base station during an international roaming comprising the steps of (a) when a central processing unit (CPU) of the cellular phone determines that an associated telephone system is different from that of the connected base station, the telephone system associated with the cellular phone accessing the data base and looking up the conversion table for retrieving a corresponding time of the connected base station with respect to the cellular phone; and (b) showing the corresponding time as a local time on a display of the cellular phone. By commanding CPU to identify two telephone systems having different time zones, it is possible of automatically converting time of a cellular phone international roaming into a local time when connected to a base station in a different time zone.

The above and other objects, features and advantages of the present invention will become apparent from the following detailed description taken with the accompanying drawings.

### BRIEF DESCRIPTION OF THE DRAWINGS

FIG. 1 is a schematic block diagram of a circuitry incorporated in a cellular phone according to the invention; and

FIG. 2 is a flow chart illustrating a process for automatically adjusting time difference of cellular phone international roaming according to the invention.

### DETAILED DESCRIPTION OF THE PREFERRED EMBODIMENTS

A method for automatically adjusting time difference of cellular phone international roaming is implemented by providing a data base in a memory 11 of cellular phone. Data base stores a time conversion table regarding information about time of one place in the world belonging to a first telephone system and a corresponding local time of another place in the world belonging to a second telephone system different from the first one. When a central processing unit (CPU) 13 of cellular phone determines that a telephone system associated with a cellular phone international roaming is different from that associated with a connected base station (i.e., in different time zones), the telephone system associated with the cellular phone will access the data base in memory 11 of cellular phone and look up the conversion table therein in order to retrieve a corresponding local time of the connected base station with respect to the cellular phone. Such obtained local time then is shown on a display 15 of cellular phone.

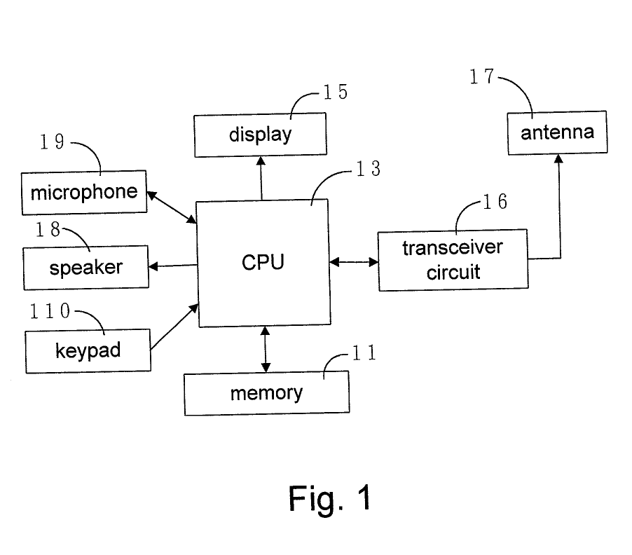

Referring to FIG. 1, the circuitry incorporated in a cellular phone according to the invention comprises a CPU 13, an antenna 17 for transmitting/receiving signals, a transceiver circuit 16 interconnecting antenna 17 and CPU 13 for permitting CPU 13 to communicate with a proximate base station, a speaker 18 for amplifying signals sent from CPU 13, and a microphone 19 for sending sound signals to CPU 13 for converting into telephone signals therein. The CPU 13 is capable of further transmitting such telephone signals to the proximate base station via transceiver circuit 16 and antenna 17. The circuitry further comprises a display 15 for display message sent from CPU 13, a memory 11 for storing data sent from CPU 13 and providing the same to CPU 13 as commanded, and a keypad 110 for user to input alphanumeric characters.

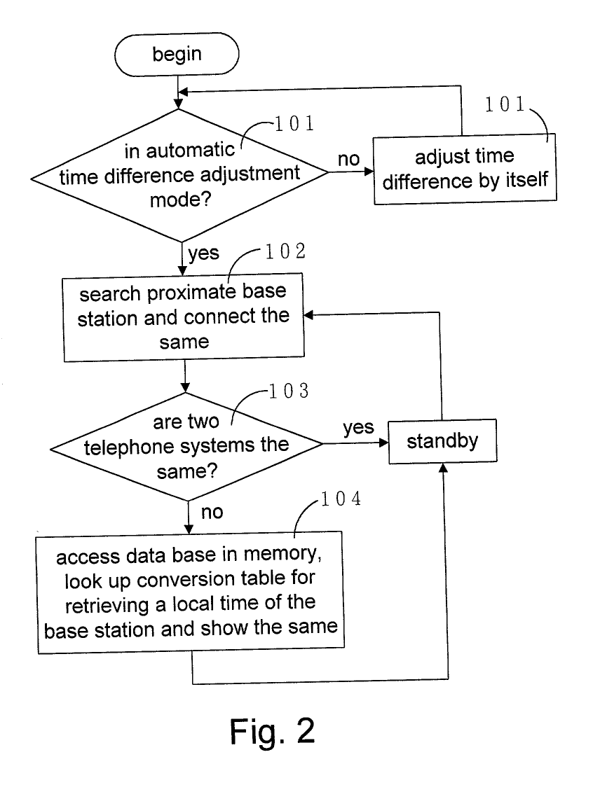

FIG. 2 is a flow chart illustrating a process according to the invention. Firstly, a person initiates an international roaming by turning on cellular phone. Then CPU 13 may perform the following steps: In step 101, determine whether an automatic time difference adjustment mode is activated. If yes, process goes to step 102. Otherwise, user does the time difference adjustment by oneself with the adjusted time shown on display 15 of cellular phone thereafter. In step 102, search a proximate base station and connect the same once found. In step 103, determine whether a telephone system associated with the cellular phone is the same as that associated with the connected base station of the cellular phone. If yes, process goes to standby mode and loops back to step 102. If not, process goes to step 104. In step 104, telephone system associated with the cellular phone will access the data base in memory 11 of cellular phone and look up the conversion table therein in order to retrieve a corresponding local time of the connected base station with respect to the cellular phone. Such obtained local time then is shown on a display 15 of cellular phone. Process then goes to standby mode and loops back to step 102.

In brief, by commanding CPU to identify two telephone systems having different time zones, it is possible of automatically converting time of a cellular phone international roaming into a local time when connected to a base station in a different time zone. In another embodiment, the cellular phone may be replaced by a personal digital assistant (PDA).

While the invention has been described by means of specific embodiments, numerous modifications and variations could be made thereto by those skilled in the art without departing from the scope and spirit of the invention set forth in the claims.

What is claimed is:

1. In a cellular phone having a memory with an embedded data base for storing a time conversion table regarding information about time of one of a plurality of places in the world belonging to a first telephone system and a corresponding time of the other place in the world belonging to a second telephone system different from said first telephone system, a method for automatically adjusting a time difference between said cellular phone and a connected base station during an international roaming comprising the steps of:
(a) when a central processing unit (CPU) of said cellular phone determines that an associated telephone system is different from that of said connected base station, said telephone system associated with said cellular phone accessing said data base and looking up said conversion table for retrieving a corresponding time of said connected base station with respect to said cellular phone; and
(b) showing said corresponding time as a local time on a display of said cellular phone.

2. The method of claim 1, wherein in step (a) when said CPU determines that said associated telephone system of said cellular phone is the same as that of said connected base station, further comprising the step of commanding said cellular phone to go to a standby mode.

3. The method of claim 1, wherein when said CPU determines that an automatic time difference adjustment mode is not activated, further comprising the step of commanding said cellular phone to do said time difference adjustment by itself and showing an adjusted time on said display thereafter.

4. The method of claim 1, wherein said cellular phone further comprises an antenna for transmitting/receiving signals, a transceiver circuit interconnecting said antenna and said CPU for permitting said CPU to communicate with said proximate base station, a speaker for amplifying signals sent from said CPU, and a microphone for sending sound signals to said CPU for converting into telephone signals therein so that said CPU is capable of transmitting said telephone signals to said proximate base station via said transceiver circuit and said antenna.

5. The method of claim 1, wherein said cellular phone further comprises a keypad for alphanumeric characters input.

6. The method of claim 1, wherein said cellular phone is implemented by a personal digital assistant (PDA).
